(19) United States
(12) Patent Application Publication
(10) Pub. No.: US 2026/0128700 A1
(43) Pub. Date: May 7, 2026

(54) CONTROLLER AND DRIVE CIRCUIT FOR ELECTRIC MOTORS

(71) Applicant: Regal Beloit America, Inc., Milwaukee, WI (US)

(72) Inventors: Ludovic Andre Chretien, Fort Wayne, IN (US); Michael R. Koller, Columbia City, IN (US)

(21) Appl. No.: 18/935,787

(22) Filed: Nov. 4, 2024

(51) Int. Cl. H02P 25/18; H02P 23/14; H02P 25/04; H02P 25/22; H02P 27/06; H02P 29/032

(52) U.S. Cl. CPC H02P 25/182; H02P 23/14; H02P 25/22; H02P 27/06; H02P 29/032; H02P 25/04; H02P 2207/01; H02P 2207/05

(57) ABSTRACT

A controller for an electric motor including a first winding and a second winding is provided. The controller includes a processor configured to supply two-phase variable frequency power to the electric motor using an inverter with a run capacitor electrically coupled to one phase of the inverter and to the second winding via a switching network, actuate the switching network to electrically decouple the run capacitor from the second winding, and, after actuating the switching network, supply three-phase variable frequency power to the electric motor.

### FIELD

The field of the disclosure relates generally to controlling electric motors, and specifically to permanent split-capacitor (PSC) and permanent magnet (PM) electric motors for compressor systems with a mechanism for modulating load on the compressor.

### BACKGROUND

At least some known induction motors are fixed speed motors that operate most efficiently at line frequency power. Such motors exhibit uncontrolled acceleration during startup. Further, at low load conditions, such motors operate less efficiently. Alternatively, some induction motors may be driven with a variable speed motor controller to adapt motor speed to a load level. Such configurations are generally limited by power factor, electromagnetic interference, and electrical losses.

A drive circuit for certain motors enables efficient operation at both high and low load conditions. For example, a motor operating a compressor in a heating, ventilation and air conditioning (HVAC) system may experience high load conditions during peak temperatures and low load conditions during milder temperatures. The drive circuit operates the motor using an inverter under low load conditions, and operates the motor using line frequency power under high load conditions.

### BRIEF DESCRIPTION

In one aspect, a controller for an electric motor is provided. The controller includes a processor configured to supply line frequency power to the electric motor through a main switching network, determine to transition from supplying line frequency power to the electric motor to supplying two-phase variable frequency power to the electric motor, synchronize a time base for controlling an output of an inverter with a voltage signal of the line frequency power, open the main switching network to cease supplying line power to the electric motor, and, after a first time period starting from opening the main switching network, supply two-phase variable frequency power to the electric motor using the inverter.

In another aspect, a method for controlling an electric motor is provided. The method includes supplying line frequency power to the electric motor through a main switching network, determining to transition from supplying line frequency power to the electric motor to supplying two-phase variable frequency power to the electric motor, synchronizing a time base for controlling an output of an inverter with a voltage signal of the line frequency power, opening the main switching network to cease supplying line power to the electric motor, and, after a first time period starting from opening the main switching network, supply two-phase variable frequency power to the electric motor using the inverter.

In another aspect, a drive circuit is provided. The drive circuit includes an electric motor, a main switching network electrically coupled to the electric motor, an inverter electrically coupled to the electric motor, and a processor. The processor is configured to supply line frequency power to the electric motor through the main switching network, determine to transition from supplying line frequency power to the electric motor to supplying two-phase variable frequency power to the electric motor, synchronize a time base for controlling an output of the inverter with a voltage signal of the line frequency power, open the main switching network to cease supplying line power to the electric motor, and after a first time period starting from opening the main switching network, supply two-phase variable frequency power to the electric motor using the inverter.

In another aspect, a controller for an electric motor including a first winding and a second winding is provided. The controller includes a processor configured to supply two-phase variable frequency power to the electric motor using an inverter with a run capacitor electrically coupled to one phase of the inverter and to the second winding via a switching network, actuate the switching network to electrically decouple the run capacitor from the second winding, and, after actuating the switching network, supply three-phase variable frequency power to the electric motor.

In another aspect, a method for controlling an electric motor including a first winding and a second winding is provided. The method includes supplying two-phase variable frequency power to the electric motor using an inverter with a run capacitor electrically coupled to one phase of the inverter and to the second winding via a switching network, actuating the switching network to electrically decouple the run capacitor from the second winding, and, after actuating the switching network, supplying three-phase variable frequency power to the electric motor.

In another aspect, a drive circuit is provided. The drive circuit includes an electric motor including a first winding and a second winding, an inverter electrically coupled to the electric motor, and a processor. The processor is configured to supply two-phase variable frequency power to the electric motor using the inverter with a run capacitor electrically coupled to one phase of the inverter and to the second winding via a switching network, actuate the switching network to electrically decouple the run capacitor from the second winding, and after actuating the switching network, supply three-phase variable frequency power to the electric motor.

### BRIEF DESCRIPTION OF THE DRAWINGS

FIG. 1 is a schematic diagram of a drive circuit for an electric motor in accordance with the present disclosure;

FIG. 2 is a schematic diagram illustrating an electrical equivalent of the drive circuit shown in FIG. 1 while operating in a first mode of operation;

FIG. 3 is a schematic diagram illustrating an electrical equivalent of the drive circuit shown in FIG. 1 while operating in a second mode of operation;

FIG. 4 is a schematic diagram illustrating an electrical equivalent of the drive circuit shown in FIG. 1 while operating in a third mode of operation;

FIG. 5 is a schematic diagram of another example drive circuit for an electric motor in accordance with the present disclosure;

FIG. 6 is a flowchart illustrating an example method for controlling an electric motor; and

FIG. 7 is a flowchart illustrating another example method for controlling an electric motor.

### DETAILED DESCRIPTION

When starting a compressor, the load on the electric motor is generally low and builds over time as suction and discharge pressures increase the torque demand on the electric motor. The torque output of the electric motor operating on line frequency power generally exceeds the starting load of the compressor, when pressures are near equal. However, if the load, i.e., the torque demand, exceeds the torque output from the electric motor, the electric motor cannot accelerate and instead decelerates, or “stalls.” For example, the electric motor cannot start if stopped, i.e., is locked; or decelerates if turning under power, i.e., stalls. This can occur after the compressor operates for a period of time to build suction and discharge pressures, creating a pressure differential across the compressor and resulting in a large torque demand. The large torque demand, i.e., large load, can generally be met if the electric motor is already turning under power; however, if the drive circuit for the electric motor has limited power output, for example, in a variable speed drive, then the electric motor may stall and decelerate when the load exceeds the maximum power output of the drive circuit. If the electric motor is stopped, the starting torque output may not overcome the load and the rotor would remain locked until the pressure differential dissipates.

At least some compressor systems include an interlock time period during which restart of the electric motor is prevented to allow the pressures to equalize. The interlock time is often on the order of several minutes in duration, during which the compressor cannot operate. Alternatively, some compressor systems include a mechanism for equalizing pressures within the compressor by introducing a bypass in the fluid system between the suction and discharge pressure chambers. The mechanism generally includes a valve in the fluid system to enable immediate pressure equalization when the compressor and electric motor are stopped. The pressure equalization mechanism may also be constructed, positioned, or otherwise incorporated external to the compressor. Alternatively, the mechanism may include a reversing valve, e.g., on heat pumps, to equalize pressures when the heat pump is stopped.

In compressor systems utilizing a hybrid drive (i.e., where the electric motor is supplied power through an inverter under low load conditions and supplied line frequency power under high load conditions), torque demand, or load, can exceed the power output capacity of the inverter or the torque output of the electric motor near the transition point (i.e., the point at which the drive circuit transitions from supplying inverter power to supplying line frequency power or transitions from supplying line frequency power to supplying inverter power). Generally, the inverter and line frequency power cannot both be connected to the electric motor at the same time, because of the potential for a line-to-line short circuit. To transition from inverter to line, or line to inverter, one is disconnected before connecting the other. When transitioning from the inverter to line frequency power, or from line frequency power to inverter power, the transient torque output at line frequency power or inverter power may fall below the torque load on the compressor, leading to a decrease in compressor speed and finally a stall condition. Or, for example, the inverter may reach a maximum current output under certain load conditions before transitioning to line frequency power or immediately upon a transition from line frequency power; the inverter may reach maximum operating temperature under certain load conditions before transitioning to line frequency power or immediately upon a transition from line frequency power; or the electric motor, given the “slip” experienced when transitioning between inverter power and line frequency power, cannot generate the torque demand under certain load conditions. Consequently, the electric motor, under high loading, could stall when attempting to transition between inverter power and line frequency power.

The embodiments described herein include a drive circuit capable of transitioning from supplying line frequency power to supplying inverter power to an electric motor such as a PSC or PM electric motor. This transition is performed in two stages. In the first stage, the drive circuit transitions from a first mode of operation in which the drive circuit supplies the electric motor with line frequency power directly from a line source to a second mode of operation in which the drive circuit supplies the electric motor with two-phase variable frequency power from an inverter. While operating in the second mode, the inverter initially supplies the two-phase variable frequency power at line frequency (e.g., fifty or sixty hertz), and then adjusts to supplying the two-phase variable frequency power at a lower target frequency (e.g., forty hertz). Once the target frequency is reached, the second stage of the transition is performed, in which the drive circuit transitions from the second mode of operation to a third mode of operation in which the drive circuit supplies the electric motor with three-phase variable frequency power from the inverter.

The drive system may include a controller configured to supply line frequency power to the electric motor through a main switching network. When the controller determines to transition from supplying line frequency power to the electric motor to supplying two-phase variable frequency power to the electric motor, the controller is configured to synchronize a time base for controlling an output of the inverter with a voltage signal of the line frequency power. The controller is configured to then open the main switching network to cease supplying line power to the electric motor, and, after a first time period starting from opening the main switching network, supply two-phase variable frequency power to the electric motor using the inverter. The first time period is selected to be long enough to prevent cross-conduction between the inverter and line while also being short enough to prevent the electric motor from stalling. The first time period may be a preset length or may be computed based on, for example, a sensed or estimated current of the electric motor.

When the two-phase variable frequency power is supplied to the electric motor, a run capacitor is electrically connected to one phase of the inverter and to the start winding of the electric motor via a second switching network (e.g., one or more relays). After operation in two-phase variable frequency power starts, the controller is configured to cause the inverter to decrease a frequency of the two-phase variable frequency power (e.g., linearly over time at a preset slew rate or rate of change) to the target frequency. When the target frequency is reached, the controller is configured to actuate the second switching network to electrically decouple the run capacitor from the start winding and, after actuating the second switching network, supply three-phase variable frequency power to the electric motor. As the second switching network is actuated, a conductive path may briefly be formed between the run capacitor, the start winding, and a third phase of the inverter, which could result in short circuit paths. To prevent such short circuit paths from forming, the controller may deactivate the inverter for a time window while the second switching network is actuating or may time the actuation of the second switching network or a switching pattern of the inverter based on a sensed parameter (e.g., a run capacitor or start winding voltage) to avoid creation of such short circuit paths.

As described above, at least some drive circuits communicate with at least one controller (e.g., a motor controller, a system controller, etc.) configured to dynamically determine when the drive circuit should transition from supplying variable frequency current from the inverter to supplying line frequency current or from supplying line frequency current to providing variable frequency current from the inverter such that the electric motor is in constant operation through the transition (e.g., no restart is required). The controller, for example, determines a maximum operating speed of the inverter (e.g., by measuring speed and current during operation at low speed) and, based on the determined maximum operating speed of the inverter, control the drive circuit to transition between supplying variable frequency power from the inverter and supplying line frequency power. The drive circuits, motor controller, and system controller may be separate circuitry or combined circuitry.

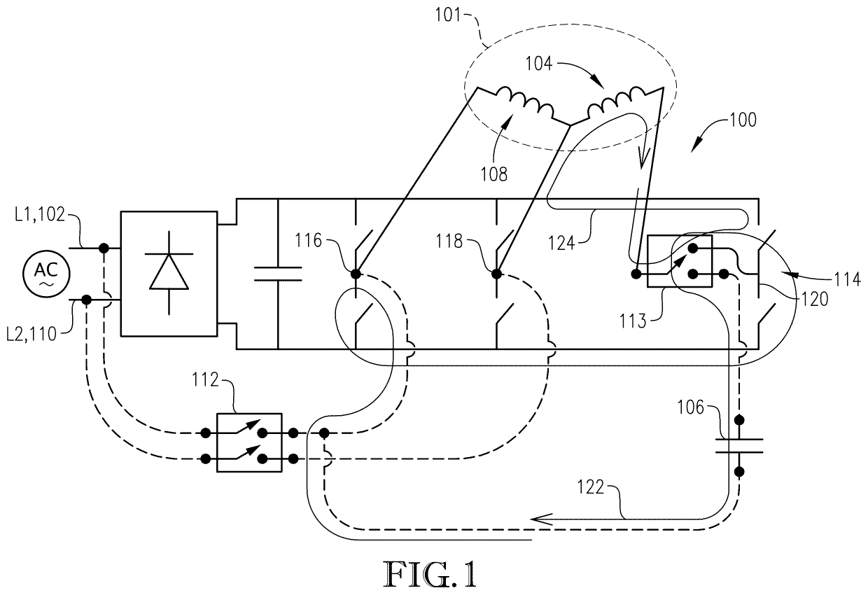

FIG. 1 is a schematic diagram of a drive circuit 100 for an electric motor 101, such as a PSC motor. During normal line frequency operation, line frequency current, such as 50 Hertz or 60 Hertz, for example, is supplied on a first line, or L1, 102, through a run capacitor 106, to a start winding 104, and to a main winding 108. A second line, or L2, 110 provides a return, or neutral, for the line frequency current. Drive circuit 100 includes a main switching network 112 for connecting and disconnecting L1 and L2 to the PSC motor. Main switching network 112 is a two pole mechanical contactor that is commutated by energizing a coil (not shown). In certain embodiments, run capacitor 106 may be coupled to L1 on either side of main switching network 112. A second switching network 113 is coupled between run capacitor 106 and start winding 104.

Drive circuit 100 includes an inverter 114 that is enabled to drive electric motor 101 with variable frequency power under low load, or at least less than full load, conditions. Drive circuit 100 is supplied line frequency power on L1 and L2. Inverter 114 enables variable speed operation of electric motor 101 by regulating amplitude, phase, and frequency of alternating current (AC) voltages on output terminals thereof, which are coupled to main winding 108 and start winding 104. When operating electric motor 101 using inverter 114, main switching network 112 is open and inverter 114 is enabled via any suitable control means, e.g., analog or digital control signals. To transition to line frequency power, inverter 114 is disabled, main switching network 112 is closed, and second switching network 113 is commutated to couple L1 and L2 directly to electric motor 101.

As shown in FIG. 1, drive circuit 100 includes six wired connections, main switching network 112, and run capacitor 106. Moreover, inverter 114 includes a first phase 116, a second phase 118, and a third phase 120. In some embodiments, first phase 116, second phase 118, and/or third phase 120 between drive circuit 100, start winding 104, and main winding 108 are integrated or tied, such that at least one connection is coupled to both main winding 108 and start winding 104. Although electric motor 101 is illustrated as a PSC motor, it is recognized that other known motors (such as permanent magnet or electronically commutated motors (ECMs)) also have integrated windings (e.g., between windings of a three-phase ECM).

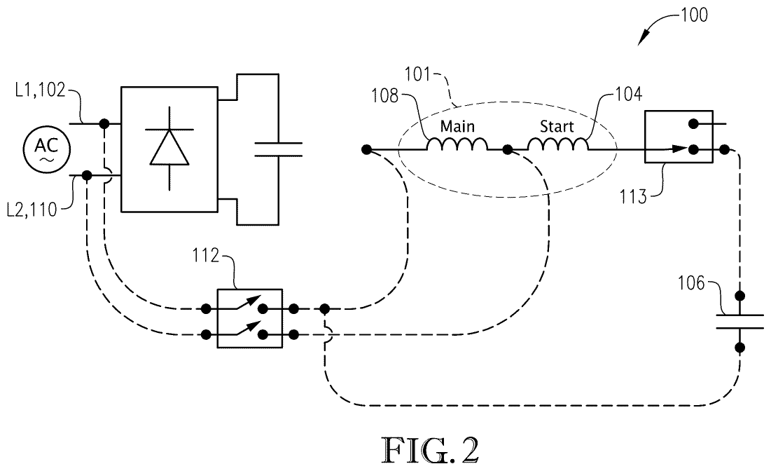

FIG. 2 illustrates an electrical equivalent of drive circuit 100 while operating in a first mode of operation in which line frequency power is supplied directly to electric motor 101 through main switching network 112. As illustrated in FIG. 2, while operating in the first mode, main winding 108 is coupled across lines L1 and L2, and start winding 104 is coupled in series with run capacitor 106, which together are coupled across L1 and L2. While operating in the first mode, under certain conditions, the controller is configured to determine to transition from supplying line frequency power to the electric motor to supplying variable frequency power to the electric motor. For example, the controller may determine to make this transition based on a received command (e.g., from a system controller) and/or based on detected parameters (e.g., current or torque demand).

In response to determining to transition to supplying variable frequency power from inverter 114, the controller is configured to synchronize a time base for controlling an output of inverter 114 with a voltage signal of the line frequency power. For example, the controller may identify a phase and frequency at which to operate the inverter without initially actually actuating any switches of inverter 114 or causing inverter 114 to supply power to main winding 108 or start winding 104.

The controller is further configured to, once the time base for controlling an output of inverter 114 is synchronized with the line frequency power, open main switching network 112 to cease supplying line power to the electric motor. In some cases, main switching network 112 may take some period of time (e.g., over one cycle) to open after being commanded due to the currents present in main switching network 112. For example, main switching network 112 may open when a zero crossing of the current occurs.

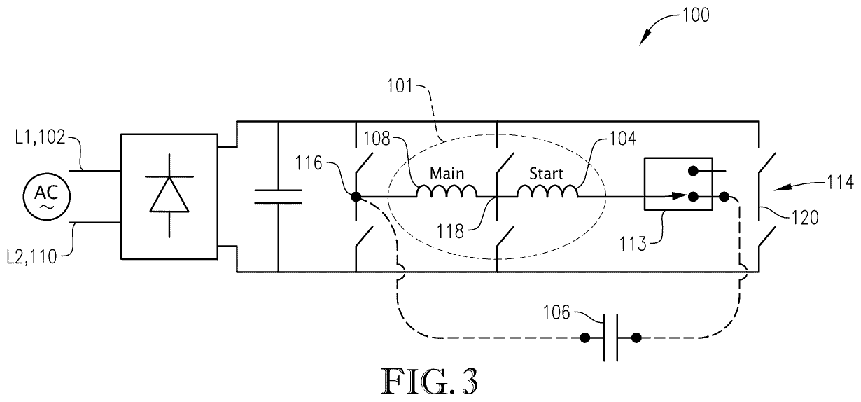

The controller is further configured to, after a first time period starting from opening main switching network 112, operate in a second mode of operation in which inverter 114 supplies two-phase variable frequency power to electric motor 101. FIG. 3 illustrates an electrical equivalent of drive circuit 100 while operating in the second mode of operation. While operating in the second mode, main winding 108 is coupled between first phase 116 and second phase 118, and start winding 104 is coupled in series with run capacitor 106 via second switching network 113, which together are coupled first phase 116 and second phase 118. This configuration enables inverter 114 to supply two-phase variable speed power to electric motor 101.

Implementing a first time period before supplying the two-phase variable frequency power reduces or prevents cross-conduction between L1 and L2 and inverter 114. The first time period is sufficiently long to avoid such cross-conduction while also being short enough (e.g., less than about five milliseconds) to avoid a stalling of electric motor 101 before power is supplied from inverter 114. The first time period may be a preset value, or the controller may be configured to compute the first time period based on a sensed or estimated compressor current. The compressor current can be estimated based on a previous load, power factor, machine model, and/or various other factors.

In some embodiments, the controller is further configured to dynamically adjust a voltage ratio, or ratio of voltage to frequency, of the two-phase variable frequency power supplied to electric motor 101 using inverter 114 while operating in the second mode of operation. For example, the voltage ratio may initially be set at a relatively high value to boost torque to avoid stalling following the first time period during which electric motor 101 is not supplied power, and the voltage ratio may then be reduced to limit harmonics and audible noise. In some such embodiments, the voltage ratio is controlled based on at least one of compressor characteristics, a learning algorithm, or an available bus voltage.

Once drive circuit 100 is operating in the second mode of operation, the controller is configured to supply two-phase variable frequency power to electric motor 101 using inverter 114 while reducing a frequency of the two-phase variable frequency power to a target frequency. Upon transition to the second mode of operation, the two-phase variable frequency power initially has a frequency synchronized with that of the line power (e.g., fifty or sixty hertz). The target frequency may be a lower frequency (forty hertz) at which inverter 114 can safely supply three-phase variable frequency power to electric motor 101 as described in further detail below. In some embodiments, the frequency of the two-phase variable frequency power is reduced over a second period of time at a designated slew rate (i.e., rate of change). This slew rate may be a preset value, or the controller may be configured to determine a slew rate based on an available voltage, a learning model (e.g., base on whether previously used slew rates did or did not result in transition failure), current harmonics content, or potential noise, vibration, or harmonics.

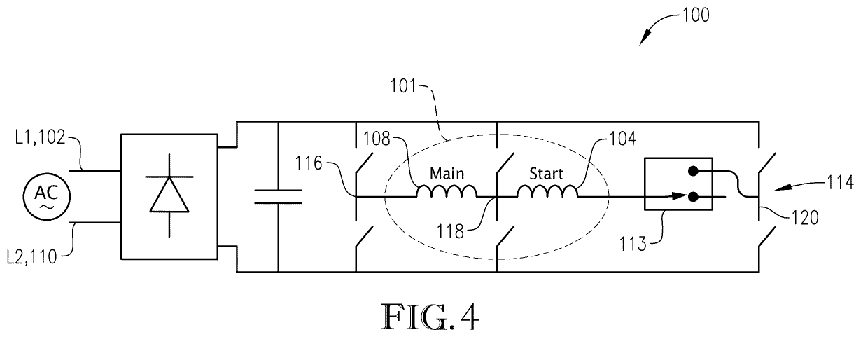

The controller is further configured to, once the two-phase variable frequency power is supplied to electric motor 101 at the target frequency, operate in a third mode of operation in which inverter 114 supplies three-phase variable frequency power to electric motor 101. FIG. 4 illustrates an electrical equivalent of drive circuit 100 while operating in the third mode of operation. While operating in the third mode, main winding 108 is coupled between first phase 116 and second phase 118, and start winding 104 is coupled between second phase 118 and third phase 120 via second switching network 113. This configuration enables inverter 114 to supply three-phase variable speed power to electric motor 101.

To transition from operating in the second mode of operation to the third mode of operation, the controller is configured to actuate second switching network 113 to electrically decouple run capacitor 106 from start winding 104 and to electrically couple start winding 104 to third phase 120 of inverter 114. Inverter 114 then supplies three-phase variable frequency power to electric motor 101 using first phase 116, second phase 118, and third phase 120. In some embodiments, inverter 114 is deactivated during this transition and begins to supply the three-phase variable frequency power after a preset time window starting from electrically decoupling run capacitor 106 from start winding 104 to avoid forming short circuits within drive circuit 100. Alternatively, in certain embodiments as described in further detail below, the controller utilizes voltage sensing to identify timing and/or switching patterns that avoid forming short circuits, which reduces or eliminates a need to deactivate inverter 114 during this transition.

In some embodiments, the controller is configured to determine a time at which to actuate second switching network 113 based on one or more detected parameters such as a main winding voltage, a position of the electric motor, or a run capacitor voltage. For example, at certain points within a cycle of inverter 114, actuating second switching network 113 could potentially short circuit run capacitor 106 or main winding 108. By detecting a main winding voltage, a position of the electric motor, or a run capacitor voltage, these points at which it is not safe to actuate second switching network 113 can be identified, and second switching network 113 can be actuate at a time that would not result in such shorting events. For example, the controller may determine when a voltage of run capacitor 106 is expected to be at a zero crossing and time an actuation of second switching network 113 to occur when the run capacitor voltage is zero to prevent a charge being maintained on run capacitor 106 after it is disconnected. Because it takes some amount of time for second switching network 113 to fully actuate, the controller may command second switching network 113 to actuate some predefined time window in advance of the desired actuation time.

In certain embodiments, the controller is further configured to, when actuating second switching network 113 to supply three-phase variable frequency power, cause the inverter to actuate one or more switches according to a switching pattern that prevents a shorting of the run capacitor and/or of the start winding. For example, as second switching network 113 actuates, conductive paths, such as conductive path 122 or conductive path 124 shown in FIG. 1, may briefly be formed that connects start winding 104, run capacitor 106, and third phase 120 of inverter 114, which could potentially lead to various short circuit paths being formed through inverter 114 depending on a present switching status of the phases of inverter 114. When these short circuit paths are present, residual charge on run capacitor 106 and/or back electromotive force (EMF) from start winding 104 could potentially result in damaging levels of current within electric motor 101 or inverter 114.

To avoid a creation of such short circuit paths, the controller may identify switches of inverter 114 that are not safe to close during actuation of second switching network 113 based on a detected voltage of run capacitor 106 and of start winding 104. If closing a particular switch of inverter 114 is determined to result in a creation of a short circuit path such as conductive path 122 or conductive path 124, the controller may control inverter 114 to open this switch during actuation of second switching network 113. In certain embodiments, the controller may identify times for opening such switches that would reduce or minimize a distortion of an ordinary switching pattern of inverter 114. For example, a time to actuate second switching network 113 may be selected that minimizes a need to distort the switching pattern of inverter 114. In other words, a time may be selected in which the ordinary switching pattern of inverter 114 would have a reduced likelihood of causing a short circuit.

In some embodiments, the controller is configured to provide overcurrent protection, in which inverter 114 is temporarily deactivated if a detected current within inverter 114 exceeds a threshold. During the transition between the second mode of operation and the third mode of operation, it may be desirable to allow for higher current levels to reduce a likelihood of electric motor 101 stalling. To accomplish this, the controller may disable overcurrent protection or raise the threshold needed to trigger overcurrent protection for a period of time during and/or following the transition to supplying three-phase variable frequency power from inverter 114.

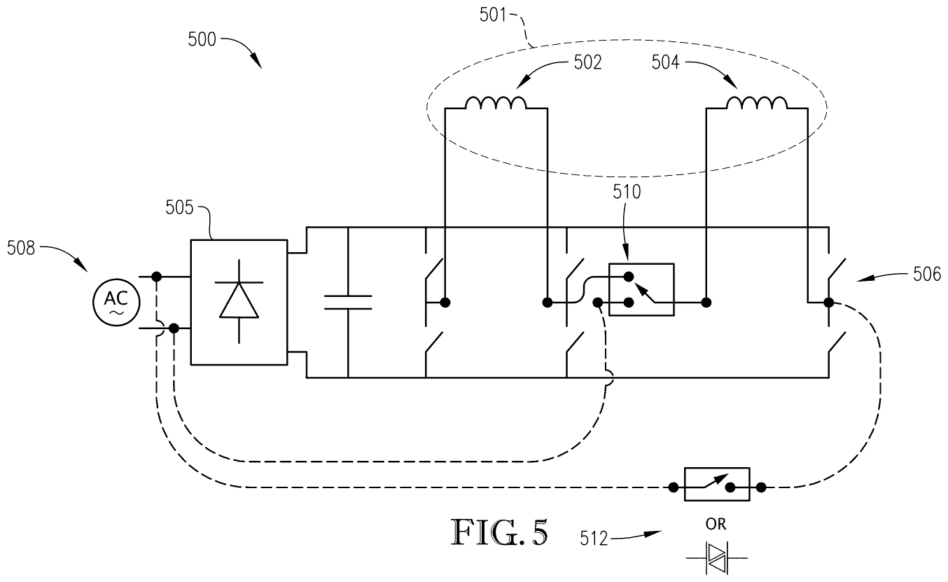

FIG. 5 is a schematic diagram of an example drive circuit 500 including an electric motor 501, which in some embodiments, is a PM electric motor. Drive circuit 500 is configured to operate in a line mode in which a first winding 502 of electric motor 501 is driven using an inverter 506 and a second winding 504 of electric motor 501 is driven directly with line frequency current from an AC source 508. Drive circuit 500 is further configured to operate in an inverter mode of operation in which first winding 502 and second winding 504 of electric motor 501 are driven using an inverter 506.

Drive circuit 500 includes a rectifier 505, inverter 506 downstream from rectifier 505, a first switch 510 (e.g., a relay) in series with second winding 504, and a second switch 512 (e.g., a contactor). First switch 510 and/or second switch 512 may be embodied as mechanical/electromechanical contactors, electronic switches, and/or or solid-state switches. In the line mode of operation, first switch 510 and second switch 512 are configured to couple second winding 504 to AC source 508, and in the inverter mode of operation, first switch 510 and second switch 512 are configured to couple second winding 504 to inverter 506. Similarly to drive circuit 100, drive circuit 500 is configured to transition from supplying second winding 504 with line frequency power from AC source 508 to supplying second winding 504 with variable frequency power from inverter 506.

Similar considerations with respect to control and timing during the transition described with respect to drive circuit 100 are also applicable to drive circuit 500. For example, any OFF-delays, timing of actuating first switch 510 and second switch 512, and switching patterns of inverter 506 may be controlled (e.g., based on sensed or estimated parameters) as described above with respect to drive circuit 100 to avoid stalling of electric motor 501, cross-conduction between inverter 506 and AC source 508, transient voltages, or short circuits.

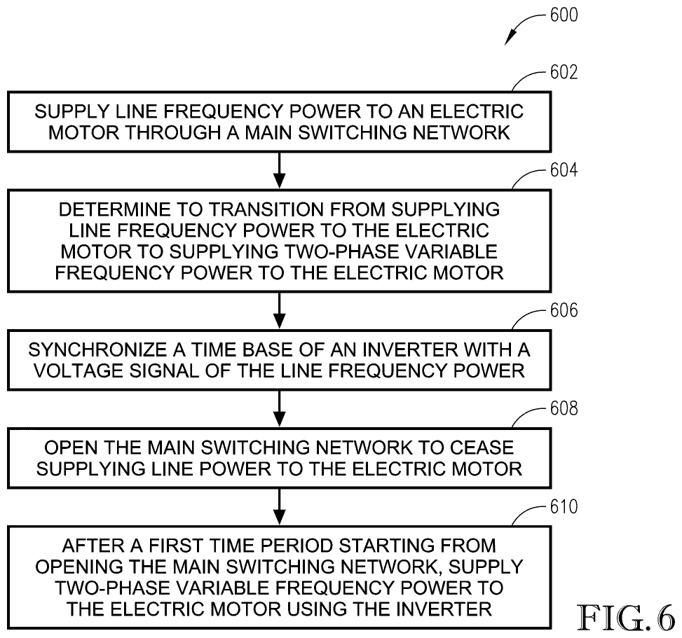

FIG. 6 is a flowchart illustrating an example method 600 for controlling electric motor 101 during a transition from the first mode of operation to the second mode of operation. Main switching network 112 supplies 602 line frequency power to electric motor 101. Drive circuit 100 determines 604 to transition from supplying line frequency power to electric motor 101 to supplying two-phase variable frequency power to electric motor 101. Drive circuit 100 synchronizes 606 a time base for controlling an output of inverter 114 with a voltage signal of the line frequency power. Main switching network 112 opens 608 to cease supplying line power to the electric motor. After a first time period starting from opening main switching network 112, inverter 114 supplies 610 two-phase variable frequency power to electric motor 101. In certain embodiments, the first time period is computed based on at least one of a sensed current or an estimated current.

In some embodiments, inverter 114 dynamically adjusts a voltage ratio of the two-phase variable frequency power supplied to the electric motor using the inverter. In some such embodiments, inverter 114 dynamically adjusts the voltage ratio based on at least one of compressor characteristics, a learning algorithm, or an available bus voltage.

In certain embodiments, while supplying two-phase variable frequency power to electric motor 101 using inverter 114, inverter 114 reduces a frequency of the two-phase variable frequency power to a target frequency. In some such embodiments, the frequency of the two-phase variable frequency power is reduced to the target frequency over a second time period at a predefined slew rate.

In some embodiments, electric motor 101 is a PSC electric motor including main winding 108 and start winding 104, and second switching network 113 electrically couples run capacitor 106 between main switching network 112 and the start winding when supplying the line frequency power or the two-phase variable frequency power to electric motor 101.

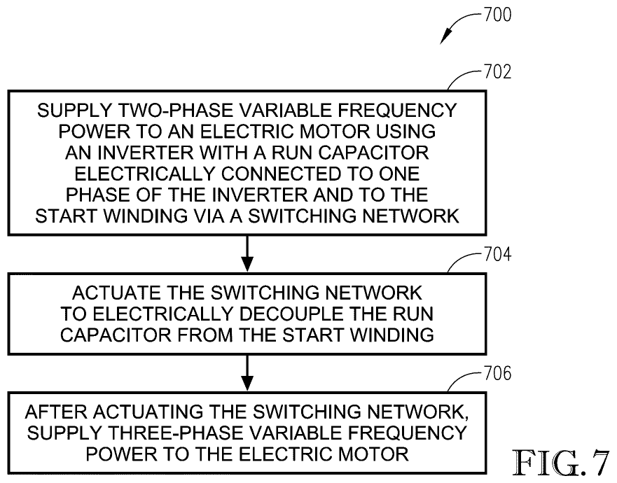

FIG. 7 is a flowchart illustrating an example method 700 for controlling electric motor 101 during a transition from the second mode of operation to the third mode of operation. Inverter 114 supplies 702 two-phase variable frequency power to electric motor 101 with run capacitor 106 electrically connected to one phase of inverter 114 and to start winding 104 via second switching network 113. Second switching network 113 actuates 704 to electrically decouple run capacitor from the start winding. After second switching network 113 actuates, inverter 114 supplies 706 three-phase variable frequency power to the electric motor.

In some embodiments, second switching network 113 is opened in response to the two-phase variable frequency power being a target frequency.

In certain embodiments, inverter 114 supplies the three-phase variable frequency power after a preset time window starting from electrically decoupling run capacitor 106 from the start winding.

In some embodiments, a time at which to actuate second switching network 113 is determined based on at least one of a main winding voltage, a position of the electric motor, or a run capacitor voltage.

In certain embodiments, while second switching network 113 is actuated, inverter 114 actuates one or more switches according to a switching pattern that prevents a shorting of run capacitor 106 based on a detected run capacitor voltage.

In some embodiments, while second switching network 113 is actuated, inverter 114 actuates one or more switches according to a switching pattern that prevents a shorting of start winding 104 based on a (e.g., detected or calculated) start winding voltage.

In certain embodiments, first phase 116 of inverter 114 is electrically coupled to main winding 108 and to run capacitor 106, second phase 118 of inverter 114 is electrically coupled to main winding 108 and to start winding 104, and inverter 114 supplies the two-phase variable frequency power through first phase 116 and second phase 118.

In some such embodiments, third phase 120 of inverter 114 is electrically coupled to second switching network 113, second switching network 113 actuates to electrically couple third phase 120 to start winding 104, and inverter 114 supplies the three-phase variable frequency power via first phase 116, second phase 118, and third phase 120.

In some embodiments, overcurrent protection is deactivated while switching network 113 is actuated.

An example technical effect of the methods, systems, and apparatus described herein includes at least one of: (a) enabling a drive circuit to transition from supplying line frequency power to an electric motor for a compressor to supplying variable frequency power to the electric motor from an inverter without stalling or deactivating the compressor; (b) preventing cross-conduction between a line input and an inverter output in a drive circuit when transitioning from supplying line frequency power to an electric motor to supplying variable frequency power to the electric motor from the inverter by determining a delay period from disconnecting the electric motor from the line frequency power and activating the inverter; and (c) preventing short circuits within a drive circuit when transitioning from supplying line frequency power to an electric motor to supplying variable frequency power to the electric motor from the inverter by selecting a time at which to decouple a run capacitor and/or controlling a switching pattern of the inverter.

Some embodiments involve the use of one or more electronic or computing devices (e.g., for controlling operation of a drive circuit and/or individual components thereof). Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the terms: processor, processing device, and controller.

In the embodiments described herein, memory may include, but is not limited to, a computer-readable medium, such as a random-access memory (RAM), and a computer-readable non-volatile medium, such as flash memory. Alternatively, a floppy disk, a compact disc - read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the example embodiment, additional output channels may include, but not be limited to, an operator interface monitor.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are examples only and are thus not limiting as to the types of memory usable for storage of a computer program.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A controller for an electric motor including a first winding and a second winding, the controller comprising a processor configured to:
supply two-phase variable frequency power to the electric motor using an inverter with a run capacitor electrically coupled to one phase of the inverter and to the second winding via a switching network;
actuate the switching network to electrically decouple the run capacitor from the second winding; and
after actuating the switching network, supply three-phase variable frequency power to the electric motor.

2. The controller of claim 1, wherein the processor is further configured to determine to open the switching network in response to two-phase variable frequency power being a target frequency.

3. The controller of claim 1, wherein the processor is further configured to supply the three-phase variable frequency power after a preset time window starting from electrically decoupling the run capacitor from the second winding.

4. The controller of claim 1, wherein the processor is further configured to determine a time at which to actuate the switching network based on at least one of a first winding voltage, a position of the electric motor, or a run capacitor voltage.

5. The controller of claim 1, wherein the processor is further configured to, while actuating the switching network, cause the inverter to actuate one or more switches according to a switching pattern that prevents a shorting of the run capacitor based on a detected run capacitor voltage.

6. The controller of claim 1, wherein the processor is further configured to, while actuating the switching network, cause the inverter to actuate one or more switches according to a switching pattern that prevents a shorting of the second winding based on a voltage of the second winding.

7. The controller of claim 1, wherein a first phase of the inverter is electrically coupled to the first winding and to the run capacitor, wherein a second phase of the inverter is electrically coupled to the first winding and to the second winding, and wherein the processor is further configured to supply the two-phase variable frequency power through the first phase and the second phase.

8. The controller of claim 7, wherein a third phase of the inverter is electrically coupled to the switching network, and wherein the processor is further configured to:
actuate the switching network to electrically couple the third phase to the second winding; and
supply the three-phase variable frequency power via the first phase, the second phase, and the third phase.

9. The controller of claim 1, wherein the processor is further configured to deactivate overcurrent protection while actuating the switching network.

10. A method for controlling an electric motor including a first winding and a second winding, the method comprising:
supplying two-phase variable frequency power to the electric motor using an inverter with a run capacitor electrically coupled to one phase of the inverter and to the second winding via a switching network;
actuating the switching network to electrically decouple the run capacitor from the second winding; and
after actuating the switching network, supplying three-phase variable frequency power to the electric motor.

11. The method of claim 10, further comprising determining to open the switching network in response to the two-phase variable frequency power being a target frequency.

12. The method of claim 10, further comprising supplying the three-phase variable frequency power after a preset time window starting from electrically decoupling the run capacitor from the second winding.

13. The method of claim 10, further comprising determining a time at which to actuate the switching network based on at least one of a first winding voltage, a position of the electric motor, or a run capacitor voltage.

14. The method of claim 10, further comprising, while actuating the switching network, cause the inverter to actuate one or more switches according to a switching pattern that prevents a shorting of the run capacitor based on a detected run capacitor voltage.

15. The method of claim 10, further comprising, while actuating the switching network, causing the inverter to actuate one or more switches according to a switching pattern that prevents a shorting of the second winding based on a voltage of the second winding.

16. A drive circuit comprising:
an electric motor comprising a first winding and a second winding;
an inverter electrically coupled to the electric motor; and
a processor configured to:
supply two-phase variable frequency power to the electric motor using the inverter with a run capacitor electrically coupled to one phase of the inverter and to the second winding via a switching network;
actuate the switching network to electrically decouple the run capacitor from the second winding; and
after actuating the switching network, supply three-phase variable frequency power to the electric motor.

17. The drive circuit of claim 16, wherein the processor is further configured to, while actuating the switching network, cause the inverter to actuate one or more switches according to a switching pattern that prevents a shorting of the run capacitor based on a detected run capacitor voltage.

18. The drive circuit of claim 16, wherein the processor is further configured to, while actuating the switching network, cause the inverter to actuate one or more switches according to a switching pattern that prevents a shorting of the second winding based on a voltage of the second winding.

19. The drive circuit of claim 16, wherein the inverter comprises:
a first phase is electrically coupled to the first winding and to the run capacitor; and
a second phase electrically coupled to the first winding and to the second winding, and
wherein the processor is further configured to supply the two-phase variable frequency power through the first phase and the second phase.

20. The drive circuit of claim 19, wherein the inverter further comprises a third phase electrically coupled to the switching network, and wherein the processor is further configured to:
actuate the switching network to electrically couple the third phase to the second winding; and
supply the three-phase variable frequency power via the first phase, the second phase, and the third phase.
